(19) United States
(12) Patent Application Publication
(10) Pub. No.: US 2005/0086325 A1
(43) Pub. Date: Apr. 21, 2005

(54) Method and apparatus for network content insertion and phase insertion

(76) Inventors: Mark W. Slipp, Oakville (CA); Warren Zajac, Barrie (CA)

Correspondence Address: MORRISON & FOERSTER LLP, 425 MARKET STREET, SAN FRANCISCO, CA, 94105-2482, US

(21) Appl. No.: 09/881,513

(22) Filed: Jun. 12, 2001

(51) Int. Cl. G06F 15/16; G06F 15/00; G06F 17/24

(52) U.S. Cl. 709/219; 709/246; 715/500.1

(57) ABSTRACT

A method and associated apparatus for modifying Internet content requests and/or content responses involves monitoring communications between a first computer and a second computer. Rules for modification may be predetermined and applied to determine whether and how content requests and/or responses are modified.

### TECHNICAL FIELD

This invention relates generally to delivery of content over a wide area network and relates specifically to a method and apparatus for content insertion and phase insertion of content over such a network.

### BACKGROUND ART

The Internet is a vehicle for exchange of content. As Internet use has grown, the complexity of the methods used to deliver content have grown as well. There are increasing needs for the efficient delivery of content. Also, there is a need for the delivery of revenue generating content that might not originate from the same source as the content that is the primary subject of a users content request. As the complexity of relevant business relationships and the complexity of handling content grows, there is an increasing need to handle content delivery at the network edges. Network edges refer to those parts of a network that are partially removed from the primary client and server host machines. In the context of the Internet, that means handling content through devices that are closely connected to either client side routers/switches or server side routers/switches.

Content based switches are known in the art. A content based switch is typically programmed to route a particular packet depending on several factors, including the contents of the packet. Such switches are sometimes used for load balancing, e.g., directing a particular request to a particular server depending on factors such as the relative geographic location of the requesting client and the server or the amount of data that must be sent to meet the request in light of the number of requests a particular server is handling. Although such switches read packet content to make decisions, those decisions are switching (i.e. routing) decisions, not by themselves impacting upon that actual content of the packet.

Data-driven, dynamically generated content is also known in the art. In other words, the exact content of a web-page might not be known until it is requested. For example, some web applications assemble a particular web page based on information about the host that requested it.

However, relying solely on a server-based web application to generate the content delivered to a host client has several drawbacks. One such drawback has to do with the limitations of such an approach to efficiently delivery of content to several different web sites simultaneously. Due to business consolidation, partnerships, or other relationships, several web-sites, though completely separate from each other from a technical perspective (i.e. no physical connection other than being connected to the Internet), might be under the business control of a common entity or a group of entities that wishes to act jointly. The resulting collection of entities may wish to insert particular pieces of content on all web-sites under their umbrella. Since these web-sites are typically not connected to the same database server, insertion of a piece of content may involve adding code to several different web-servers. Such code may be simply a reference pulling a portion of content from another web-server. This may allow content on a collection of web-sites to be changed without corresponding repetitive code changes, e.g., code and/or content data may be changed only on a single server that sources the particular content. However, if the IP (Internet Protocol) address of the source server changes, then corresponding code changes would be necessitated on each of the web-servers relying on that server.

For other reasons, it may be desirable to add content that is not dependent on code residing on servers at the target destination of the client's request. An Internet Service Provider (ISP), may desire to present content to clients based on information about the client and based on information about the client's request.

For any type of content insertion, performance is an issue. It is important to provide a system and a device that can carry out content insertion with minimal disruption to the delivery of the primary content that the client has requested and minimum disruption to the communication process between requesting client and destination server.

### SUMMARY OF THE INVENTION

The present invention provides a method and an apparatus for carrying out content insertions and phase insertions based on information derived from a packet or packets comprising the client computer's request message and may also be based upon elements of the host server's response message to that request. The present invention may be implemented on either the client-side edge or the server-side edge of the Internet cloud.

### BRIEF DESCRIPTION OF THE DRAWINGS

The novel features of the invention are set forth in the appended claims. However, for purpose of explanation, several aspects of an embodiment of the invention are described by reference to the following figures.

FIG. 1 illustrates a client side implementation of an insertion device in conjunction with either a router or an L4 switch in accordance with an embodiment of the present invention.

FIG. 2 illustrates a server side implementation of an insertion device in conjunction with a router or an L4 switch in accordance with an embodiment of the present invention.

FIG. 3 illustrates a process in accordance with an embodiment of the present invention for connection and communication between a requesting client, a destination server, and an insertion device in which content is inserted by the insertion device into content originating from the destination server and sent to the client.

FIG. 4 illustrates an example of data flow between a requesting client, a destination server, and an insertion device.

FIGS. 5a and 5b illustrate a process in accordance with an embodiment of the present invention for connection and communication between a requesting client, a destination server, and an insertion device in which the insertion device sends phase inserted data to the client prior to delivering the requested data from the destination server.

FIG. 6 is a board level diagram of the hardware architecture of an insertion device in accordance with an embodiment of the present invention.

FIG. 7 is a flow chart illustrating packet processing carried out by an insertion device in accordance an embodiment of the present invention.

FIG. 8 is a more detailed view of packet processing and retransmission carried out by an insertion device in accordance with an embodiment of the present invention.

### DETAILED DESCRIPTION OF THE DRAWINGS

In the following description, numerous details are set forth for purpose of explanation. However, one of ordinary skill in the art would realize that the invention may be practiced without the use of these specific details. In other instances, well-known structures and devices are shown in block diagram form in order not to obscure the description of the invention with unnecessary detail.

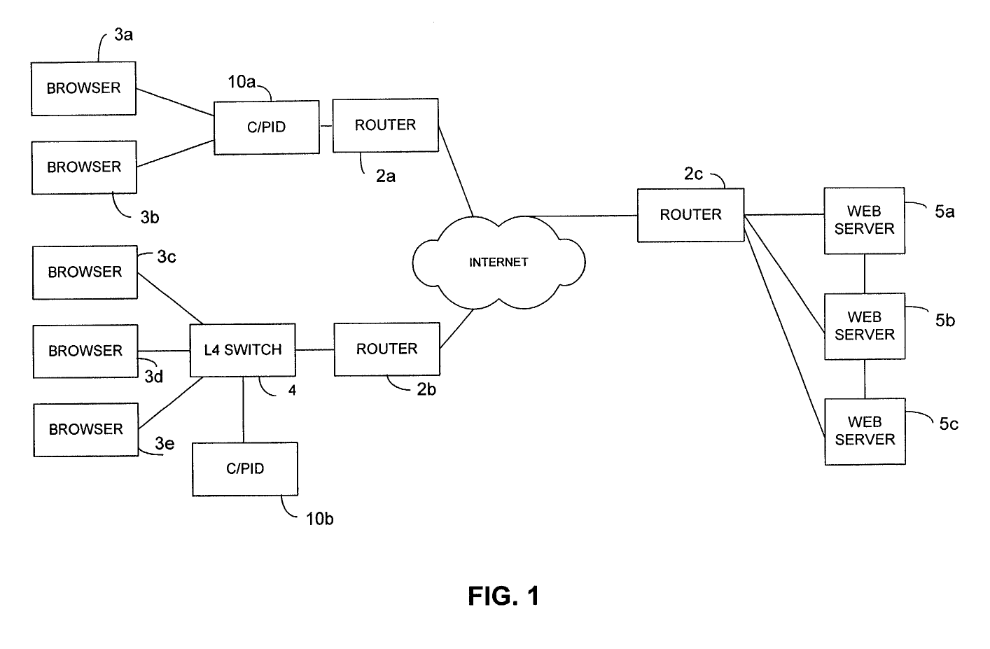

FIG. 1 illustrates two alternative client edge implementations for connecting a content/phase insertion device (“C/PID”). A C/PID is a device designed for either or both of the following tasks: (1) insert content into existing content destined for a client (“content insertion”) or (2) deliver content to a client while that client is waiting to receive other content that the client has requested (“phase insertion”).

The connection of C/PID 10b illustrates implementation of a C/PID in a network already containing an L4 (“layer 4”) switch. C/PID 10b is connected in an alternative client edge implementation in which a router 2b is connected to L4 (“layer 4”) switch 4. An L4 switch is a device that can make switching decisions based on information about the content of a packet. For example, when forwarding a packet to browser 3c, L4 switch 4 might make and implement a decision selecting one of a plurality of forwarding pathways (plurality of pathways and intervening network devices not shown) between L4 switch 4 and the computer running browser 3c based in part upon information about the content of the packet (e.g. size). C/PID 10b is connected to L4 switch 4 as shown. Note that with the illustrated implementation, even if C/PID 10b goes offline, network traffic continues through L4 switch 4.

If, however, an existing network does not already contain an L4 switch, a C/PID containing an L4 switch such as C/PID 10a may be connected to router 2a as shown. C/PID 4a has a built-in L4 switch (L4 switch not separately shown). Router 2a routes Internet packets to and from connected client computers running browser programs 3a, 3b, 3c, 3d, and 3e.

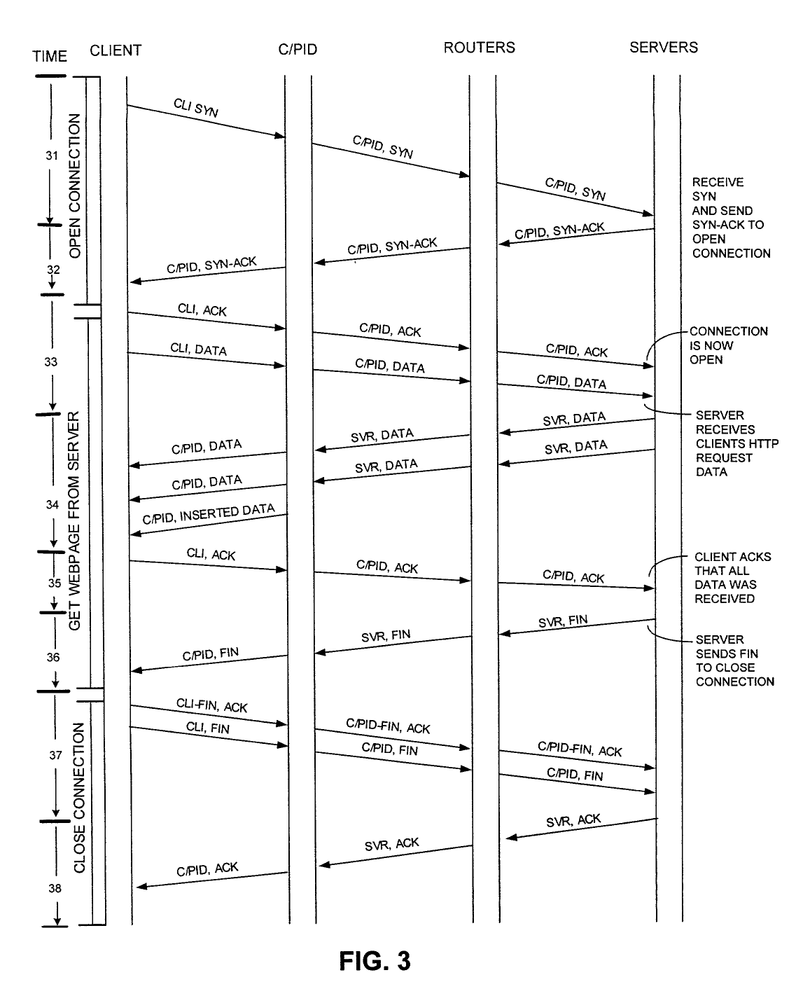

A client side edge implementation of a C/PID may be appropriate in various contexts. In particular, such an implementation may be advantageous to an Internet Service Provide (ISP) providing Internet access to a number of connected client customers. An ISP may utilize a C/PID to insert transparent revenue generating content into web pages requested by and delivered to client computers. Because ISP's may have limited proprietary rights to such pages, it is important as explained in the text describing FIG. 3 below, that such insertions have a “watermark” or transparent quality with respect to the actual requested pages. In other words, in general the layout and text of such pages should not be changed due to the content insertion.

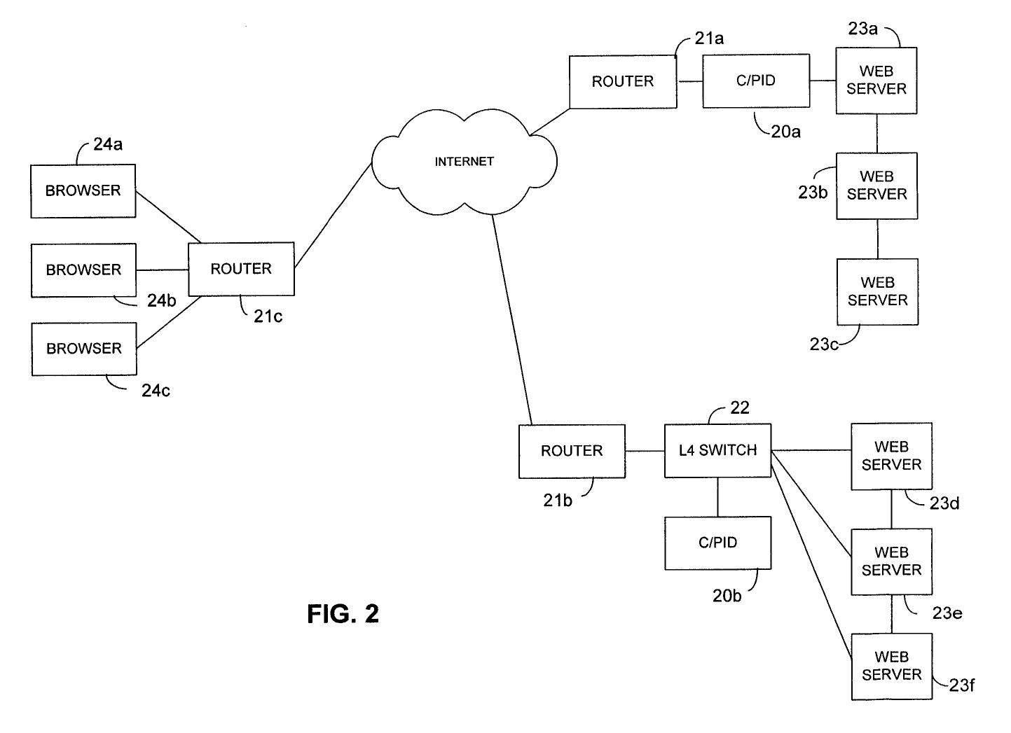

FIG. 2 illustrates a server side edge implementation of C/PIDs in accordance with the present invention. C/PID 20a contains an incorporated L4 switch (L4 switch not separately shown) and is connected to router 21a. C/PID 20b is connected to L4 switch 22.

A server side edge implementation may be useful for a number of purposes. For example, entities running a collection of web servers that would like to flexibly brand a particular group of web-sites without changing code on each server might do so via C/PID 20a, which could insert content into requested packets delivered by web servers 23a-c, or via C/PID 20b, which could insert content into requested packets delivered by web-servers 23c-f. Alternatively, a router such as 21a might be servicing one or more email servers and a C/PID such as C/PID 20a could be used to insert a standard corporate mark onto all outgoing emails.

FIG. 3 illustrates an example of how a C/PID in a client edge implementation carries out communication with both client and server in order to insert content data into the content data that the client has requested from the server (i.e. content insertion). Throughout the process, the C/PID is intermediate to the client and server. The C/PID may establish it's intermediate position in at least two alternative manners. In a first alternative, it may establish separate http connections between itself and the client and itself and the server. Under this first alternative, the C/PID generates and sends it's own connection messages (SYN, ACK, FIN as described below) to both the server and the client. In a second alternative, it may simply forward connection messages sent from the client to the server and from the server to the client. The second alternative may have the advantage of permitting less delay in transmission times between client and server In the second alternative, the C/PID may simply forward packets without examining them in detail, or, if there are packets that might potentially match a requirement that the C/PID perform further processing, the C/PID would monitor the last sequence number of the packet stream and potentially other details such as the source host, source port, last ACK sequence number, destination port, or the destination host. In either the first or second alternative, the C/PID may monitor communication between server and client and, when those communications match an appropriate ruleset, the C/PID may insert data into appropriate packets or packet streams.

If a client-edge Firewall or NAT (Network Address Translation) server is in place between the C/PID and the client users, all of the unique client users transmitting and receiving requests that travel through the C/PID will have their individual unique IP address blocked and re-assigned as the NAT or Firewall IP address. In such instances, the C/PID will still need distinguish between individual client users. Using a customized cookie inserted into the client's request, the C/PID can distinguish between users when they are behind a NAT or firewall server. The C/PIED can also use a persistent HTTP (Hyper Text Transfer Protocol) connection to maintain which user is which. The C/PID can also use the NAT or firewall servers IP and source port number to uniquely identify each user (or rather each connection from the internal network).

Returning the communication time line illustrated in FIG. 3, the process begins with the current typical HTTP three-way handshake for establishing a client-server connection. That hand shake is generally composed of the following steps: (1) client sends a request to open a connection (“SYN” request) with a server, (2) server sends acknowledgement (“ACK” message) of the client request and sends a SYN request to open connection with the client, and (3) client sends an ACK of the server's request, completing the 3-way handshake for opening a connection. The client may also send the actual data request (e.g. a “GET” request for a particular web page) at the time the client sends the ACK of the server's SYN request.

As illustrated, the C/PID inserts itself into the HTTP handshake process. Illustrated beginning at the upper-left hand corner of FIG. 3, during time segment 31, the client computer initiates a communication by sending a SYN request to a server. The C/PID intercepts that request. The C/PID may intercept the request and send its own SYN request to the appropriate server OR may simply forward that request to the server (this alternative in which the C/PID simply relays connection messages rather than sending it's own new connection messages is referenced parenthetically in the remaining portion of this description of FIG. 3). During time segment 32, after the server receives the SYN request from the C/PID, the server sends an ACK message to the C/PID along with a SYN request to open a connection with the C/PID (if the C/PID has simply forwarded the client's SYN request rather than send it's own SYN request to the server, then the server's SYN-ACK message will be directed to the client rather than to the C/PID; in either case, the request will travel to the C/PID on it's way to the client). After the C/PID receives the server's ACK and SYN, the C/PID sends it's own ACK of the client's original SYN request and also sends a SYN requesting to open a connection with the client (or simply forwards the server's SYN-ACK if directed to the client). Alternatively, the C/PID might have sent an ACK and SYN to the client as soon as it received the client's SYN request, or after sending a SYN to the server but prior to receiving an ACK/SYN back from the server. However, the approach as illustrated has the advantage that, if the server is not responding, the C/PID will not ACK a SYN from the client unless the server is available. Thus, as illustrated, the C/PID waits to receive the ACK/SYN from the server before sending an ACK/SYN responsive to the client's SYN request.

After receiving the ACK message and SYN request from the C/PID, during time segment 33, the client sends an ACK message responsive to the C/PID's SYN (or responsive to the server's SYN). When the ACK reaches the C/PID device, the 3-way handshake between the client and the C/PID is complete and an HTTP connection is now open between the client and the C/PID. The C/PID then completes its handshake with the server by sending an ACK of the server's SYN request. When the ACK reaches the server, the 3-way handshake between the C/PID and the server is complete and an HTTP connection is open between the C/PID and the server (or, if the C/PID has simply been forwarding messages between client and server, at this point the three-way handshake between client and server is complete and an HTTP connection is open between client and server).

After the client has sent its ACK of the C/PID's SYN, the client may start sending data requests, also during time segment 33. Although the user at the client computer believes it is sending the request to the server, the client is actually sending its data request to the C/PID. The C/PID then requests the same data from the server that the client has requested (or simply forwards the client's request). During time segment 34, the server responds to the C/PID (or client) with data as shown. When the server responds to the C/PID (or client) with the requested data, the C/PID may simply send the same data to the client, or may add additional data as shown. During time segment 35, after the client receives the requested data (and any inserted data), the client sends an ACK to the C/PID acknowledging receipt of the data. The C/PID then sends an ACK (or simply forward's the client ACK) to the server acknowledging receipt of the requested data. During time segment 36, after the server has received the ACK from the C/PID, the server begins the process of closing the connection by sending a FIN message. When the C/PID receives the FIN message, the C/PID sends a FIN message to the client (or simply forwards the server's FIN message). During time segment 37, the client then sends an ACK of the C/PID's FIN message and sends it's own FIN message. After the C/PID receives the ACK/FIN from the client, the C/PID sends an ACK of the server's FIN message and sends its own FIN message to the server (or simply forwards the client's FIN message). During time segment 38, the server completes the process of closing the connection by sending an ACK of the C/PID's FIN. Once the C/PID receives the final ACK from the server, the C/PID sends an ACK to the client's FIN (or forwards the server's ACK) and, when the client receives this ACK, the HTTP connection is closed.

As discussed above in the description of FIG. 2, it may be important that content insertions, such as C/PID inserted data sent to the client during time segment 34 of FIG. 3, have a “watermark” or transparent quality with respect to the actual requested pages (such as the other data originated from the server and sent from C/PID to client during time segment 34 of FIG. 3). In other words, in general the layout and text of such pages should not be changed due to the content insertion. Below is an example of JavaScript code that achieves a watermark type content insertion to a requested page:

```
JAVASCRIPT:
<style>
#divBottom{position:absolute; font-family:arial,helvetica; height:64 width:64; font-size:12pt; font-
weight:bold; background:white}
</style>
<script language=“JavaScript1.2” type=“text/javascript”>
/***********************************************************************
Copyright (C) 1999 Thomas Brattli
This script is made by and copyrighted to Thomas Brattli at www.bratta.com
Visit for more great scripts.
This may be used freely as long as this msg is intact!
***********************************************************************/
/***********************************************************************Remember to
set the look of the divBottom layer in the stylesheet (if you want
another font or something)
***********************************************************************/
/*Set these values, gright for how much from the right you want the layer to go
and gbottom for how much from the bottom you want it*/
var gright=132
var gbottom=80
//Browsercheck
var n = (document.layers) ? 1:0;
var ie = (document.all) ? 1:0;
/***********************************************************************
Constructing the ChangeText object
***********************************************************************/
function makeObj(obj,nest){
    nest=(!nest) ? “:‘document.’+nest+‘.’
    this.css=(n) ? eval(nest+‘document.’+obj):eval(obj+‘.style’)
    this.moveIt=b_moveIt;
}
function b_moveIt(x,y){
    this.x=x; this.y=y
    this.css.left=this.x
    this.css.top=this.y
}
/***********************************************************************
Initializing the page, getting height and width to moveto and calls the
object constructor
***********************************************************************/
var pageWidth,pageHeight
function geoInit( ){
    oTest=new makeObj(‘divBottom’)
    pageWidth=(ie)?document.body.offsetWidth−4:innerWidth;
    pageHeight=(ie)?document.body.offsetHeight−2:innerHeight;
    checkIt( )
    //sets the resize handler.
    onresize=resized
    if(ie) window.onscroll=checkIt;
}
/***********************************************************************This function
executes onscroll in ie and every 30 millisecond in ns
and checks if the user have scrolled, and if it has it moves the layer.
***********************************************************************/
function checkIt( ){
    if(ie) oTest.moveIt(document.body.scrollLeft +pageWidth−
gright,document.body.scrollTop+pageHeight−gbottom)
    else if(n){
        oTest.moveIt(window.pageXOffset+pageWidth−gright, window.pageYOffset+pageHeight−
gbottom)
        setTimeout(‘checkIt( )’,20)
    }
}
//Adds a onresize event handler to handle the resizing of the window.
function resized( ){
    pageWidth=(ie)?document.body.offsetWidth−4:innerWidth;
    pageHeight=(ie)?document.body.offsetHeight−2:innerHeight;
    if(ie) checkIt( )
}
//Calls the geoInit onload
onload=geoInit;
//Here we will write the div out so that lower browser won't see it.
//if(n ∥ ie) document.write(‘<div id=“divBottom”>JavaScript<br>Resources</div>’)
if(n ∥ ie) document.write(‘<div align=“right” id=“divBottom”><img
src=“http://www.contentbridge.net/weblandicon.jpg” border=“0”></div>’)
</SCRIPT>
```

One alternative to a watermark-type insertion is a pop-up window type insertion which may also be accomplished through javascript code. Such a window may be closed by the user, leaving the underlying requested page intact.

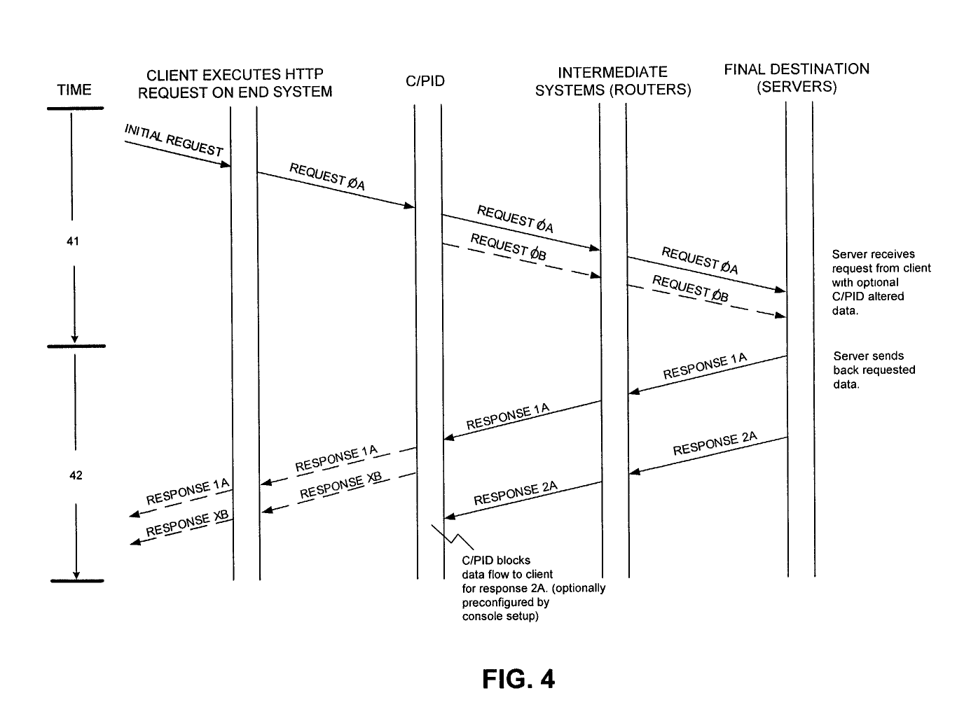

FIG. 4 illustrates that content insertion may occur on the outgoing request from the client to the server as well as on the incoming data response as illustrated in FIG. 3. FIG. 4 also illustrates blocking data responses. During time segment 41, the client sends request 0A. The C/PID inserts additional request data 0B and sends request 0B along with request 0A to a server. During time segment 42, the server sends back response 1A and response 2A. Response 1A and 2A together are the data responsive to request 0A and 0B. Also, as illustrated during time segment 42, the C/PID might block part of a server data response. As illustrated, the C/PID blocks response 2A, forwards response 1A, and adds newly inserted data response XB.

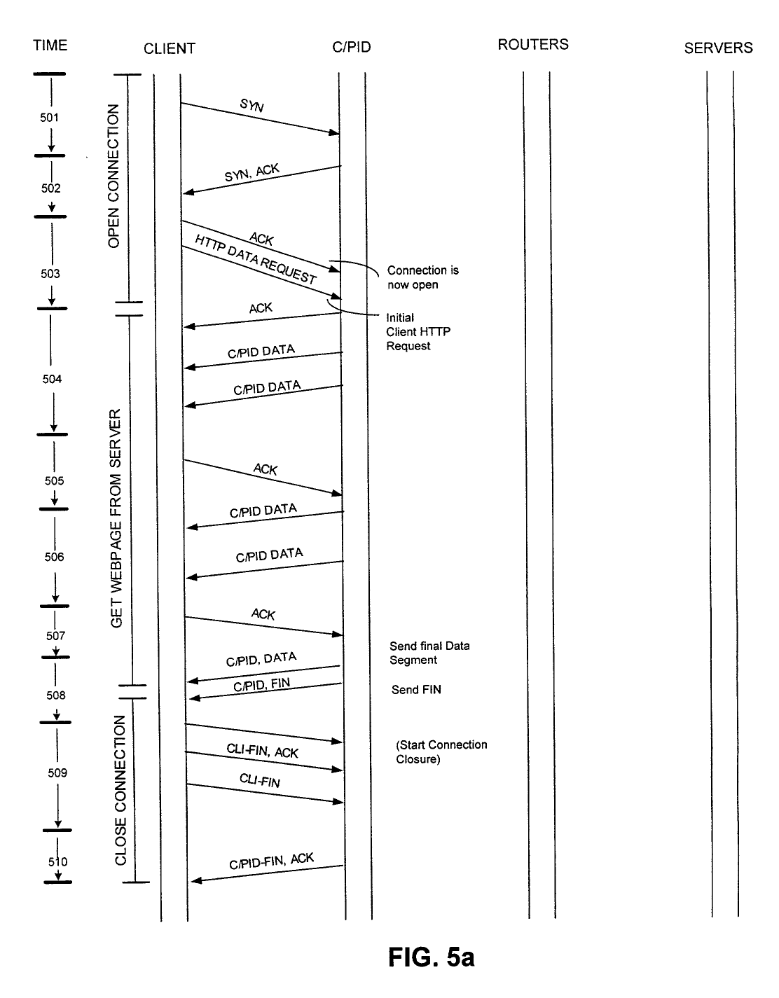

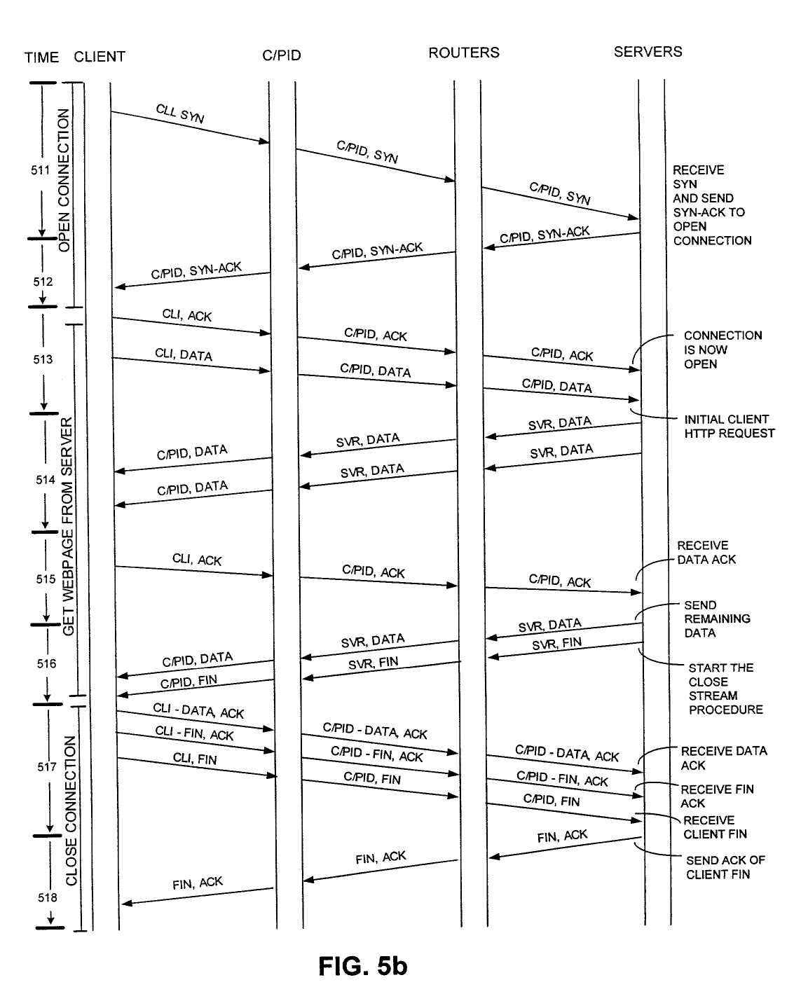

FIG. 5a shows an exemplary procedure for communication in which the C/PID carries out phase insertion instead of content insertion. With phase insertion, rather than adding content to a data response from the server, data is sent from the C/PID to the client before any data has been or received from any server. During time segment 501, when the client sends out its SYN request, the C/PID intercepts that request and does not send a SYN request to the server. Instead, during time segment 502, the C/PID continues the handshake with the client by sending an ACK and SYN to the client. During time segment 503, the client sends an ACK and once the ACK is received by the C/PID, an HTTP connection is open. During time segment 503, the client might also send a data request. During time segment 504, the C/PID sends and ACK of the client's data request and then sends phase inserted data (e.g. advertising) to the client. During time segment 505, the client acknowledges receipt of the data. During time segment 506, the C/PID then sends more phase inserted data. During time segment 507, the client acknowledges receipt of the data. In the illustrated example, during time segment 508, the C/PID send a final phase inserted data segment and then begins the close connection procedure by sending a FIN message. During time segment 509, the client returns an ACK of the data, an ACK of the FIN, and the client sends it's own FIN. During time segment 510, once the C/PID sends and the client receives the ACK of the client's FIN, then the HTTP connection is closed.

FIG. 5b illustrates communication once the client requests again the original server page that it has not yet received. After the connection illustrated in FIG. 5a is closed, the client will refresh it's original request and initiate a new connection during time segment 511. The C/PID again intercepts the client request and checks its internal tables to see whether or not the client has already received phase inserted data. With a client-side Firewall or NAT (Network Address Translation) server, all of the unique users using the C/PID will have their individual unique IP address blocked and re-assigned as the NAT or Firewall IP address. Using a customized cookie inserted into the client's request, the C/PID can distinguish between users when they are behind a NAT or firewall server. The C/PID can also use a persistent HTTP connection to maintain which user is which. As a final note, the C/PID can also use the NAT or firewall servers IP and source port number to uniquely identify each user (or rather each connection from the internal network).

Once the C/PID discovers that the client has already received phase inserted data, the C/PID sends a SYN to the server (or simply forward the client's SYN) and communication proceeds as previously described (see FIG. 3 and accompanying text): During time segment 512 the server sends an ACK and SYN to the C/PID and the C/PID sends an ACK and SYN to the client (or forwards the server's ACK and SYN); during time segment 513, the client sends an ACK and a data request to the C/PID and the C/PID sends an ACK and a data request to the server (or forwards the client's ACK and data request); during time segment 514, the server sends data to the C/PID and the C/PID sends the data to the client; during time segment 515 the client sends an ACK of the data to the C/PID, the C/PID sends an ACK of the data to the server (or forward's the client's ACK); during time segment 516, the sever may send more data and send a FIN message to the C/PID to begin closing the connection and the C/PID sends the data and a FIN to the client (or sends the data and forwards the server's SYN); during time segment 517 the client sends an ACK of the data, an ACK of the FIN, and a FIN to the C/PID and the C/PID sends an ACK of the data, an ACK of the FIN and a FIN to the server (or simply forwards the respective client messages); during time segment 18 the server sends an ACK of the FIN to the C/PID, thereby closing the connection with the C/PID, and finally the C/PID sends an ACK of the FIN (or forwards the server's ACK) to the client to complete the closing of the connection with the client.

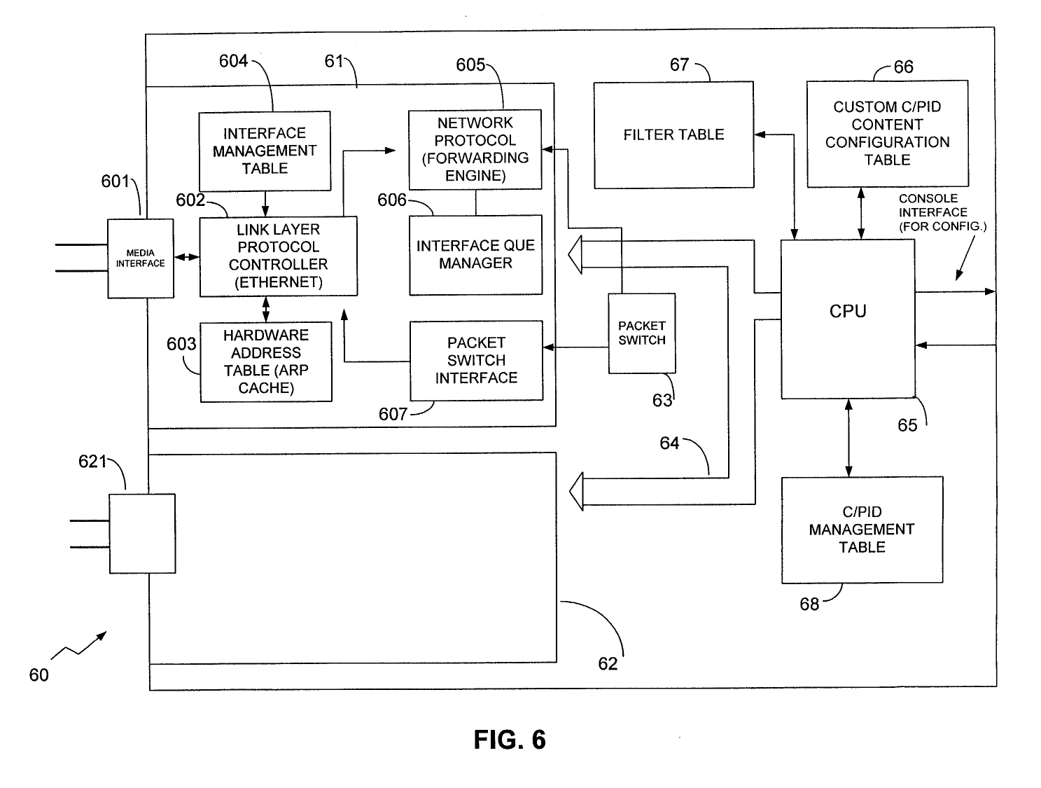

FIG. 6 Shows an exemplary hardware architecture for a C/PID 60 built in accordance with the present invention. C/PID 60 includes input/output interfaces 61 and 62, packet switch 63, bus 64, CPU 65, content configuration table 66, filter table 67, management table 68. C/PID 60 also has a console interface (not shown) for entering configuration commands. C/PID 60 also has a global memory (not separately shown).

Each input/output interface 61 and 62 is responsible for interfacing with different networks (networks interfaced with not shown). The different networks may be of the same type or of different types. A C/PID such as C/PID 60 might have a larger (or lesser) number of input/output interfaces for interfacing with a greater (or lesser) number of different networks. For simplicity, the details only are shown of input/output interface 61. Input/output interface 61 includes media interface 601, link layer protocol controller 602, hardware address table 603, interface management table 604, forwarding engine 605, interface queue manager 606, and packet switch interface 607.

The interface 61 may be or resemble a LAN Network Interface Card (NIC). In the preferred embodiment, a customized interface 61 as shown includes elements not found in a typical NIC. For example, a typical NIC would not have a forwarding engine such as forwarding engine 605 and might not have a hardware address table such as hardware address table 603. In an alternative embodiment utilizing a typical NIC, elements performing functions such as hardware address table 603 and forwarding engine 605 would have to reside outside the NIC and, in a likely configuration, would utilize the C/PID's central processor.

In the preferred embodiment shown, neither interface 61 nor interface 62 have separate memories but rather communicate with the C/PID's global memory. In this manner, a packet can be stored once and then multiple interfaces, such as interface 61 and interface 62 can read the packet out of the global memory without the memory location of the packet having to be changed. In an alternative embodiment, an interface such as interface 61 or 62 would have separate local memory.

Media interface 601 receives physical signals that it translates into binary data and the received packets are processed by link layer protocol controller 602, which handles the link layer protocol (e.g. HDLC, Ethernet) used over the physical link (e.g. cable). Link layer protocol controller 602 also checks the received frame integrity (size, checksum, address, etc). Valid frames are converted to packets by removing the link layer header and are queued in a receive queue such as interface queue manager 606 that may utilize space in global memory as the receive queue. This receive queue is a First-In-First-Out (FIFO) queue, implemented, for example, in the form of a ring memory buffer.

The queue buffers are passed (or drained) into an input of forwarding engine 605. Forwarding engine 605 then starts processing the network layer information. It reads the network layer (IP) packet headers and checks various parts of the header, to ensure the packet is not damaged or illegal. It then uses a local forwarding table (in global memory, not separately shown) to identify whether or not the packet requires further processing. If the packet does not require further processing, it will be sent to an appropriate output interface determined by checking interface management table 604. The output interface might be output interface 61 including media interface 601, however, it might be another output interface such as output interface 62 which would have another media interface such as media interface 621. Output interface 62 containing media interface 621 might be for interfacing to a different type of network than that interfaced to by output interface 61 including media interface 601. If the packet does require further processing, it will be sent to CPU 65. Once the appropriate destination has been identified, the forwarding engine then requests packet switch 63 to form a connection to the appropriate destination interface (e.g. media interface 601 or CPU 65). Packet switch 63 in the present embodiment takes the form of a shared memory data structure in which all received packets are stored. The switching operation therefore consists of removing a pointer from the receive queue, and copying the value of the pointer to the appropriate transmit queue.

Each out-going packet requires a new link layer protocol header to be added (encapsulation) with the destination address set to the next system to the receive the packet. Link protocol controller 602 also maintains hardware address table 603. Hardware address table 603 uses the Address Resolution Protocol (ARP) to find out the hardware (Medium Access Control) addresses of other computers or routers directly connected to the same cable (or LAN). The packets are finally sent with the hardware address set to the next system hop. When complete, the buffer (memory) allocated to the frame is “freed”, that is, it is returned as an empty buffer to the receive queue, where it may be used to store a new received packet.

In the preferred embodiment, packet data is left in the same place as it was received (the global memory buffer) and, rather than passing the packet itself, the C/PID passes information about where a packet is stored in memory. Doing this will help speed up the delivery of each packet to its destination.

The processing of packets is implemented in the general purpose processor CPU (central processing unit) 65. One example of a processor for use as CPU 65 is a Motorola 68K Cold Fire. CPU 65 implements all the C/PID special networking algorithms including content insertion and phase insertion.

Filter table 67 is usually manually configured, and contains a list of addresses and other packet header details which, if they match a received packet, will cause the packet to be examined in detail and possibly rejected by the C/PID processor. This may be used to prevent unauthorized packets being forwarded (ex: to act like a firewall). This type of table may also be called an Access Control List (ACL), and may become very complex in some C/PID implementations. The filter table contents are maintained by the rules stored in the content configuration table 66. In an alternative embodiment, in which interfaces such as interface 61 or 62 have a separate memory, the contents of a filter table 67 could be loaded into each interface after the CPU is reconfigured or restarted.

Filter table 67 contains the low level rules such as IP address, port number, and protocol (e.g. TCP/UDP/etc) that will be loaded into the memory space utilized by forwarding engine 605 (i.e. a space in global memory in the illustrated preferred embodiment or a space in a memory local to the interface in an alternative embodiment) for wire speed packet processing. If any of these rules are matched the packet (memory pointer) will be forwarded to CPU 65 for further processing.

Content configuration table 66 contains all of the rule information for each rule added to C/PID 60. Each rule may have multiple search and match results and certain defined criteria that must be matched before a content insertion or phase insertion may take place. Content configuration table 66 is where the rules are saved to allow C/PID 60 to function in a particular manner.

Management table 68 contains information about the basic operation of the C/PID device in its current network environment. The management table contains the local network and netmask, the local gateway IP address. It also contains access security information for obtaining access to the C/PIDs management system and configuration.

The C/PID acts to monitor packets and to perform content insertion or phase insertion when particular request or response packets match rules that may be predetermined. A type of rule that might be implemented is the following:
Insert a script into an all requests that have index.html in the request. Only do this insert for users using the IP address 10.1.4.5 (source).

There are a multiple ways content might be inserted into such a request. For example: a URL, embedded javascript code, and/or embedded html code might be used to insert content. Three example rules implementing the above rule type are as follows:

### EXAMPLE 1A

### Using a URL to Add Content to the index.html Page

Where headers string has “get” and “index.html” insert string from “HTTP://10.0.0.1/scripts/script.jbs” and IPsource=0.0.0.0/0 and IPdestination=10.1.4.5/32.

### EXAMPLE 1B

### Using an Embedded Script to Add Content to the index.html Page

Where headers string has “get” and “index.html” insert string from “<JavaScript> do something</JavaScript>” and IPsource=0.0.0.0/0 and IPdestination=10.1.4.5/32.

### EXAMPLE 1C

### Using Embedded html Code/Source to Add Content to the index.html Page

Where headers string has “get” and “index.html” insert string from “<html> do something</html>” and IPsource=0.0.0.0/0 and IPdestination=10.1.4.5/32.

Examples 1A-1C all work on the same principal, the only difference is where and what is inserted into the index.html page. (Note: all three examples could exist in a single C/PID device. The result would be all three rules adding their content to the html page. This is allowed because these commands are insert commands and the rules will be executed in sequence. If the rule needs to do searches and replacing content using the same search, a setting can be used to specify what string to find. Using a unique specified number for the first occurrence, second occurrence, etc. the C/PID can make changes based on each occurrence or data in the packet.)

This rule is stored in content configuration table 66 and is referenced last to make a final decision whether all the specified criteria has been met and a change needs to be made.

In this example C/PID 60 is monitoring all traffic for the users on the IP address 10.1.4.5 and watches for a web page request that contains “index.html”. If this match is found, C/PID 60 will obtain the script or text from the local http://10.0.0.1/scripts/script.jbs and place the content obtained from this source into the index.html page the client requested. The content in the script file (or text file) could be html code, JavaScript code or other information that needs to be inserted into this web page.

The IP address masking as discussed above would work like the following:
An address of 0.0.0.0/0 is the equivalent to an address of 0.0.0.0 and a net mask of 0.0.0.0. (This example specifies all IP addresses)
An address of 10.1.4.5/32 is the equivalent to an IP address of 10.1.4.5 and a net mask of 255.255.255.255. (This example specifies a single IP address)
An address of 10.1.4.0/24 is the equivalent to an IP address of 10.1.4.0 and a net mask of 255.255.255.0. (This example specifies an entire class ‘C’ address range.)

The format of the addresses is a network x.x.x.x and then the number of bits in the net mask /y. If the net mask were equal to 255.255.255.224, then y would equal 27.

Forwarding engine 605 stores information in global memory that might include the source and destination address information. In this example it would store 0.0.0.0/0 as the source and 10.1.4.5/32 as the destination. When forwarding engine 605 receives a packet, the destination and source IP address is checked with the forwarding engine tables and the packet is either directly passed on to the processor for processing or forwarded out of C/PID 60 to its destination address. The forwarding engine can also look at the destination and source port numbers associated with a received packet and make the same decision. (This was not shown in the above example.)

Filter table 67 will look at the more intricate details of a received packet to make a decision. The filter table takes into account specific details about the rule that need to be checked. In the above example, the filter table would look for a “get” with an “index.html” string in the received packet. If this is found, the filter will forward the received packet to the processor for final rule processing.

CPU 65 will process a packet for possible content insertion only when the filter table and forwarding engine determines that this is packet matches the rules set in place by the rule set definition set in the content configuration table. CPU 65 will then look at the rule set and then execute any changes set forth by the matching rule set. Afterwards the packet is set back out the network with its new changes made.

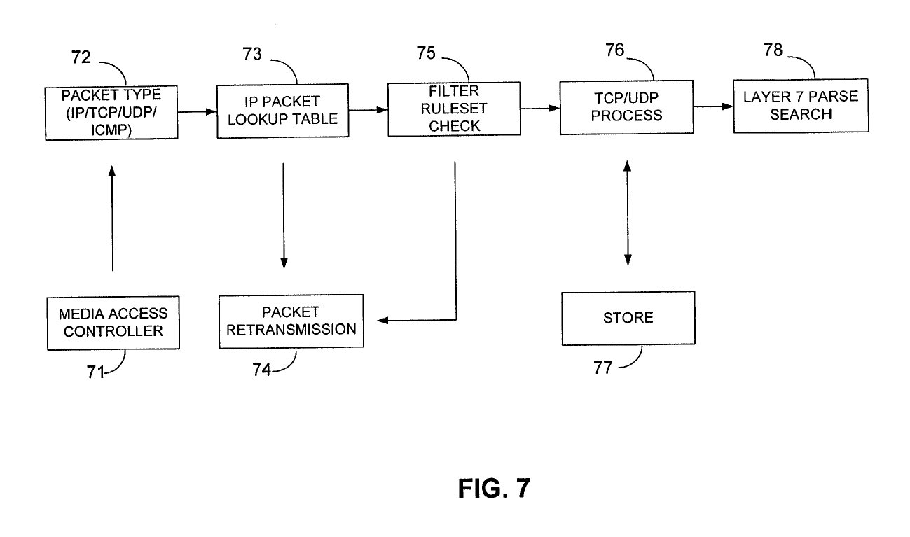

FIG. 7 is a flow diagram illustrating processing carried out by C/PID 60. A packet sent out over an Ethernet network connection is received and initially processed at Media Access Controller block 71. At block 71, the Ethernet frame encapsulating the packet is stripped off. Next, at packet type block 72, the C/PID determines which transport protocol type the packet is (IP/TCP/UDP/ICMP). Next, at IP packet lookup block 73 the C/PID next reads the IP address information associated with the packet (for example, the source IP, the destination IP, the source port, the destination port) and performs a lookup against it's internal IP address table. If the IP does not match an IP in it's internal table, the C/PID prepares the packet for retransmission (e.g. re-encapsulates the packet with appropriate headers), as indicated by packet retransmission block 74, and the packet is then forwarded to its original destination without further processing. However, if at IP lookup block 73 the IP address does match one stored in a table, then, at filter ruleset check block 75, a ruleset check is done on the packet to see if an applicable rule exists for performing a content or phase insertion. If a rule does not apply, then the packet is pre-prepared for retransmission as indicated by the arrow from filter ruleset check block 75 to packet retransmission block 74. If a rule does apply, then, at TCP/UDP process block 76, store block 77, and layer 7 parse search block 78, the packet is buffered while a layer 7 parse search is performed. The layer 7 parse search just extracts certain elements from the received packet (for example a destination port of 80 would resolve to the http protocol and a port of 25 would resolve to the smtp-mail protocol) and then compares the information gathered to the rules outlined in the C/PID configuration table in order to process some change with the sequence of packets being sent/received.

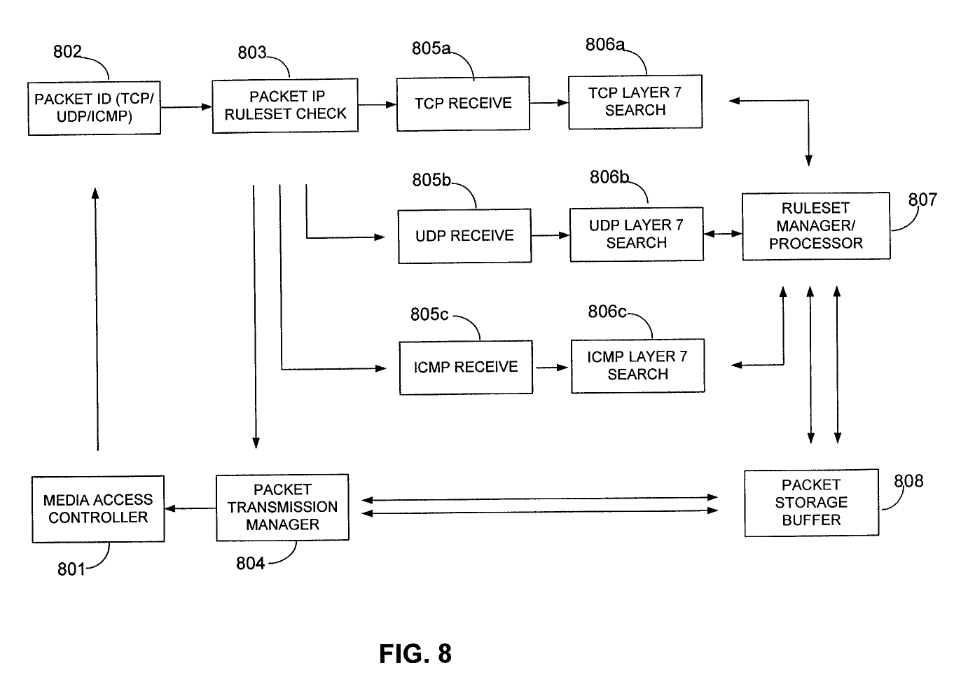

FIG. 8 illustrates a similar processing flow to that illustrated in FIG. 7 but the processing flow illustrated by FIG. 8 is shown in more detail. As illustrated in FIG. 8, separate process paths are used depending on whether the packet type is TCP, UDP, or ICMP. At packet ID block 802, the packet type is determined. At ruleset check block 803, a ruleset check is done on the packet to see if an applicable rule exists for performing a content or phase insertion. If a rule does not apply, then the packet is pre-prepared for retransmission as indicated by the arrow from ruleset check block 803 to packet retransmission block 804. If the packet matches a rules set, then it is forward along one of the following process paths depending on packet type: TCP receive block 805a and TCP layer 7 search block 806a; UDP receive block 805b and UDP layer 7 search block 806b; or ICMP receive block 805c and ICMP layer 7 search block 806c. At ruleset manager block 807, the applicable rule is applied, and at packet transmission manager block 804, packet storage buffer block 808, and media access controller 801, the packet is taken from storage and readied for forwarding back through the network.

At Media Access Controller block 801, the steps are performed necessary to execute a communication link between the physical network and the C/PID hardware.

While particular embodiments of the invention have been described in detail, various modifications to these embodiments can be made without departing from the spirit and scope of the invention. Thus, the invention is limited only by the appended claims.

1. A method for inserting second content into first content requested over the Internet by a first computer from a second computer and sent by the second computer over the Internet to the first computer comprising:
intercepting a request to establish a connection with the second computer sent by the first computer;
establishing a connection with the second computer and with the first computer;
receiving a request for the first content sent by the first computer;
sending the request for the first content to the second computer;
receiving a response from the second computer containing the first content; and
sending the first content and the second content to the first computer.

2. The method of claim 1 further comprising:
searching for a pre-determined rule for insertion based on the information contained in the request for content sent by the first computer to the second computer wherein the second content is sent to the first computer only if a pre-determined rule for insertion indicates that second content should be sent to the first computer.

3. The method of claim 2 wherein searching for a pre-determined rule is performed prior to forwarding the request to the second computer.

4. The method of claim 1 further comprising:
searching for a pre-determined rule for insertion based on the information contained in the response sent by the second computer containing the first content wherein the second content is sent to the first computer only if a pre-determined rule for insertion indicates that the second content should be sent to the first computer.

5. The method of claim 2 further comprising, prior to searching for a pre-determined rule for insertion:
checking IP address information associated with the request;
if the IP address information does not match pre-determined IP address information to which a rule for insertion might apply, forwarding the requested content to the first computer without searching for a pre-determined rule for insertion.

6. The method of claim 4 further comprising, prior to searching for a pre-determined rule for insertion:
checking IP address information associated with the response;
if the IP address information does not match pre-determined IP address information to which a rule for insertion might apply, forwarding the requested content to the first computer without searching for a pre-determined rule for insertion.

7. A method for inserting second content into first content requested over the Internet by a first computer from a second computer and sent by the second computer over the Internet to the first computer comprising:
monitoring communications between the first computer and the second computer;
receiving a request for the first content sent by the first computer;
sending the request for the fist content to the second computer;
receiving a response from the second computer containing the first content; and
sending the first content and the second content to the first computer.

8. The method of claim 7 further comprising:
searching for a pre-determined rule for insertion based on the information contained in the request for content sent by the first computer to the second computer wherein the second content is sent to the first computer only if a pre-determined rule for insertion indicates that the second content should be sent to the first computer.

9. The method of claim 8 wherein searching for a pre-determined rule is performed prior to forwarding the request to the second computer.

10. The method of claim 7 further comprising:
searching for a pre-determined rule for insertion based on the information contained in the response sent by the second computer containing the first content wherein the second content is sent to the first computer only if a pre-determined rule for insertion indicates that second content should be sent to the first computer.

11. The method of claim 8 further comprising, prior to searching for a pre-determined rule for insertion:
checking IP address information associated with the request;
if the IP address information does not match pre-determined IP address information to which a rule for insertion might apply, forwarding the requested content to the first computer without searching for a pre-determined rule for insertion.

12. The method of claim 10 further comprising, prior to searching for a pre-determined rule for insertion:
checking IP address information associated with the response;
if the IP address information does not match pre-determined IP address information to which a rule for insertion might apply, forwarding the requested content to the first computer without searching for a pre-determined rule for insertion.

13. (canceled)

14. A method for inserting second content into first content requested over the Internet by a first computer from a second computer and sent by the second computer over the Internet to the first computer comprising:
steps for monitoring communications between the first computer and the second computer;
steps for receiving a request for the first content sent by the first computer;
steps for sending the request for the first content to the second computer;
steps for receiving a response from the second computer containing the first content; and
steps for sending the first content and the second content to the first computer.

15. The method of claim 14 further comprising:
steps for searching for a pre-determined rule for insertion based on the information contained in the request for content sent by the first computer to the second computer wherein the second content is sent to the first computer only if a pre-determined rule for insertion indicates that the second content should be sent to the first computer.

16. The method of claim 15 wherein searching for a pre-determined rule is performed prior to forwarding the request to the second computer.

17. The method of claim 14 further comprising:
steps for searching for a pre-determined rule for insertion based on the information contained in the response sent by the second computer containing the first content wherein the second content is sent to the first computer only if a pre-determined rule for insertion indicates that second content should be sent to the first computer.

18. The method of claim 15 further comprising, prior to searching for a pre-determined rule for insertion:
steps for checking IP address information associated with the request;
steps for, if the IP address information does not match pre-determined IP address information to which a rule for insertion might apply, forwarding the requested content to the first computer without searching for a pre-determined rule for insertion.

19. The method of claim 17 further comprising, prior to searching for a pre-determined rule for insertion:
steps for checking IP address information associated with the response;
steps for, if the IP address information does not match pre-determined IP address information to which a rule for insertion might apply, forwarding the requested content to the first computer without searching for a pre-determined rule for insertion.

20. A device for inserting second content into first content requested over the Internet by a first computer from a second computer and sent by the second computer over the Internet to the first computer comprising:
means for monitoring communications between the first computer and the second computer;
means for receiving a request for the first content sent by the first computer;
means for sending the request for the first content to the second computer;
means for receiving a response from the second computer containing the first content; and
means for sending the first content and the second content to the first computer.

21. The device of claim 20 further comprising:
means for searching for a pre-determined rule for insertion based on the information contained in the request for content sent by the first computer to the second computer; and
means for sending the second content to the first computer only if a pre-determined rule for insertion indicates that the second content should be sent to the first computer.

22. The device of claim 21 wherein the means for searching for a pre-determined rule performs the searching for a pre-determined rule prior to forwarding the request to the second computer.

23. The device of claim 20 further comprising:
means for searching for a pre-determined rule for insertion based the information contained in the response sent by second computer containing the first content; and
means for sending the second content is sent to the first computer only if a pre-determined rule for insertion indicates that the second content should be sent to the first computer.

24. The device of claim 21 further comprising:
means for checking IP address information associated with the request;
means for, if the IP address information does not match pre-determined IP address information to which a rule for insertion might apply, forwarding the requested content to the first computer without invoking the means for searching for a pre-determined rule for insertion.

25. The device of claim 23 further comprising:
means for checking IP address information associated with the response;
means for, if the IP address information does not match pre-determined IP address information to which a rule for insertion might apply, forwarding the requested content to the first computer without invoking the means for searching for a pre-determined rule for insertion.

26. The method of claim 1 claim 21 wherein the second content is transparent relative to the overall display and layout of the first content.

27. A method for delivering second content to a first computer that has requested first content over the Internet from a second computer before the first computer receives the first content comprising:
intercepting a request to establish a connection with the second computer sent by the first computer;
establishing a connection with the first computer;
receiving a request for the first content sent by the first computer;
delivering the second content to the first computer;
receiving a re-request for the first content from the first computer;
requesting the first content from the second computer;
receiving the first content from the second computer; and
sending the first content to the first computer.

28. The method of claim 27 further comprising:
searching for a pre-determined rule for insertion based on the information contained in the request sent by the first computer to the second computer;
wherein the second content is sent to the first computer only if a pre-determined rule for insertion indicates that the second content should be sent to the first computer.

29. The method of claim 28 wherein searching for a pre-determined rule is performed prior to forwarding the request to the second computer.

30. A device for delivering second content to a first computer that has requested first content over the Internet from a second computer before the first computer receives the first content comprising:
means for intercepting a request to establish a connection with the second computer sent by the first computer;
means for establishing a connection with the first computer;
means for receiving a request for the first content sent by the first computer;
means for delivering the second content to the first computer;
means for receiving a re-request for the first content from the first computer;
means for requesting the first content from the second computer;
means for receiving the first content from the second computer; and
means for sending the first content to the first computer.

31. The device of claim 30 further comprising:
means for searching for a pre-determined rule for insertion based on the information contained in the request sent by the first computer to the second computer;
means for sending the second content to the first computer only if a pre-determined rule for insertion indicates that the second content should be sent to the first computer.

32. The device of claim 31 wherein the means for searching for a pre-determined rule performs the searching for a pre-determined rule prior to forwarding the request to the second computer.

33. The device of claim 31 further comprising:
means for checking IP address information associated with the request;
means for, if the IP address information does not match pre-determined IP address information to which a rule for insertion might apply, forwarding the requested content to the first computer without invoking the means for searching for a pre-determined rule for insertion.

34. A device for inserting second content into first content requested over the Internet by a first computer from a second computer and sent by the second computer over the Internet to the first computer comprising:
means for monitoring communications between the first computer and the second computer;
means for receiving a request for the first content sent by the first computer;
forwarding means for checking for first criteria in the request for first content, communicating information associated with the request for first content to a filtering means if the first criteria matches first pre-determined criteria indicating that a rule for insertion might apply to the request for first content, and forwarding the request to the second computer without further processing if the first criteria does not match the first pre-determined criteria;
the filtering means being for checking for second criteria in the request for first content, communicating information associated with the request for first content to a content insertion means if the second criteria matches second pre-determined criteria indicating that a rule for insertion might apply to the request for first content, and triggering forwarding of the request for first content without further processing if the second criteria does not match the second pre-determined criteria;
the content insertion means being for triggering sending of the second content to the first computer with the first content if the request for first content matches a pre-determined rule triggering insertion.

35. A device for inserting second content into first content requested over the Internet by a first computer from a second computer and sent by the second computer over the Internet to the first computer comprising:
means for monitoring communications between the first computer and the second computer;
means for receiving a response sent by the second computer responsive to the request for first content sent by the first computer;
forwarding means for checking for first criteria in the response communicating information associated with the response to a filtering means if the first criteria matches first pre-determined criteria indicating that a rule for insertion might apply to the response, and forwarding the response to the first computer without further processing if the fist criteria does not match the first pre-determined criteria;
the filtering means being for checking for second criteria in the response, communicating information associated with the response to a content insertion means if the second criteria matches second pre-determined criteria indicating that a rule for insertion might apply to the response, and triggering forwarding of the request for first content without further processing if the second criteria does not match the second pre-determined criteria;
the content insertion means being for triggering sending of the second content to the first computer with the first content if the response matches a pre-determined rule triggering insertion.

36. A method for modifying first content requested over the Internet by a first computer from a second computer and sent by the second computer over the Internet to the first computer comprising:
monitoring communications between the first computer and the second computer;
receiving a request for the first content sent by the first computer;
sending the request for the first content to the second computer;
receiving a response from the second computer containing the first content;
modifying the first content to create modified content; and
sending the modified content to the first computer.

37. The method of claim 36 further comprising:
searching for a pre-determined rule for modification based on the information contained in the request for content sent by the first computer to the second computer wherein the modified content is created and sent to the first computer only if a pre-determined rule for modification indicates that first content should be modified and otherwise the first content is sent to the first computer without being modified.

38. The method of claim 36 further comprising:
searching for a pre-determined rule for modification based on the information contained in the response sent by the second computer containing the first content wherein the modified content is created and sent to the first computer only if a pre-determined rule for modification indicates that first content should be modified and otherwise the first content is sent to the first computer without being modified.

39. The method of claim 37 further comprising, prior to searching for a pre-determined rule for modification:
checking IP address information associated with the request;
if the IP address information does not match pre-determined IP address information to which a rule for modification might apply, forwarding the requested content to the first computer without searching for a pre-determined rule for modification.

40. The method of claim 38 further comprising, prior to searching for a pre-determined rule for modification:
checking IP address information associated with the response;
if the IP address information does not match pre-determined IP address information to which a rule for modification might apply, forwarding the requested content to the first computer without searching for a pre-determined rule for modification.

41. The method of any of claims 36-40 wherein modifying includes blocking delivery of at least a portion of the first content to the first computer.

42. A method for modifying a request for first content, the first content being requested over the Internet by a first computer from a second computer comprising:
monitoring communications between the first computer and the second computer;
receiving the request for the first content sent by the first computer;
modifying the request for first content to create a modified content request; and
sending the modified request to the second computer or to another computer.

43. The method of claim 42 further comprising:
searching for a pre-determined rule for modification based on the information contained in the request for first content wherein the modified request is created only if a pre-determined rule for modification indicates that the request for first content should be modified and otherwise the request for first content is sent to the second computer without modification.

44. The method of claim 43 further comprising, prior to searching for a pre-determined rule for modification:
checking IP address information associated with the request;
if the IP address information does not match pre-determined IP address information to which a rule for modification might apply, forwarding the request for first content to the second computer without searching for a pre-determined rule for modification.
